(19) United States
(12) Patent Application Publication
(10) Pub. No.: US 2013/0177729 A1
(43) Pub. Date: Jul. 11, 2013

(54) ARTICLE ATTACHABLE TO AN EXTERIOR SURFACE OF A VEHICLE AND METHOD OF FORMING THE ARTICLE

(71) Applicants: Catherine A. Ostrander, Grand Blanc, MI (US); Kitty L. Gong, Macomb, MI (US); Charles K. Buehler, Lansing, MI (US); Chris A. Oberlitner, Shelby Township, MI (US)

(72) Inventors: Catherine A. Ostrander, Grand Blanc, MI (US); Kitty L. Gong, Macomb, MI (US); Charles K. Buehler, Lansing, MI (US); Chris A. Oberlitner, Shelby Township, MI (US)

(73) Assignee: GM GLOBAL TECHNOLOGY OPERATIONS LLC, Detroit, MI (US)

(21) Appl. No.: 13/343,763

(22) Filed: Jan. 5, 2012

(51) Int. Cl. B29C 45/17; B29C 45/72; B32B 3/02; B29C 45/14

(52) U.S. Cl. 428/68; 264/279; 264/275; 264/101

(57) ABSTRACT

A method of forming an article attachable to an exterior surface of a vehicle includes heating a thermoplastic system to form a workpiece. The thermoplastic system includes a substrate having an end surface, and a film disposed on the substrate and having a distal surface adjoining the end surface. The workpiece has a first surface adjoining the distal surface to define a distal edge, and a second surface spaced opposite the first surface and adjoining the end surface to define a proximal edge between the second and end surfaces. The method includes disposing the workpiece between a mold surface and a pressure surface. After disposing, the method includes conforming the first surface to one of the pressure and mold surfaces to form a preform, and depositing an injection-moldable polymer onto the preform to form a protective layer thereon that contacts and covers the distal surface. An article is also disclosed.

### TECHNICAL FIELD

The present disclosure generally relates to an article attachable to an exterior surface of a vehicle, and to a method of forming the article.

### BACKGROUND

Vehicles often include distinctive badging, such as emblems, to denote a brand and/or manufacturer of the vehicle. Such emblems are generally designed to convey a positive and easily-recognizable association between the vehicle and the manufacturer of the vehicle, and are therefore often attached to visible exterior surfaces of the vehicle, e.g., front grilles, rear liftgates and trunks, and/or wheel covers. Any defect or degradation of the emblem may diminish the perceived quality of the vehicle and/or tarnish the reputation of the vehicle manufacturer.

### SUMMARY

A method of forming an article attachable to an exterior surface of a vehicle includes heating a thermoplastic system to form a workpiece. The thermoplastic system includes a substrate having an end surface, and a film disposed on the substrate and having a distal surface adjoining the end surface. The workpiece has a first surface adjoining the distal surface to define a distal edge therebetween, and a second surface spaced opposite the first surface and adjoining the end surface to define a proximal edge between the second surface and the end surface. The method also includes disposing the workpiece between a mold surface and a pressure surface spaced apart from the mold surface. After disposing, the method includes conforming the first surface to one of the pressure surface and the mold surface to thereby form a preform. Further, the method includes depositing an injection-moldable polymer onto the preform to form a protective layer and thereby form the article, wherein the protective layer contacts and covers the distal surface.

In one embodiment, the method includes disposing the workpiece between the mold surface and the pressure surface so that the first surface faces the mold surface and the second surface faces the pressure surface. Further, the first surface and the mold surface define a first cavity therebetween, and the second surface and the pressure surface define a second cavity therebetween. After disposing, the method includes conforming the first surface to the mold surface to thereby form the preform, wherein conforming includes concurrently evacuating the first cavity and pressurizing the second cavity to thereby dispose the first surface in contact with the mold surface. In addition, the method includes depositing the injection-moldable polymer onto the preform to form the protective layer thereon and thereby form the article, wherein the protective layer contacts and covers the second surface and the distal surface. Further, depositing includes injection molding the injection-moldable polymer onto the preform so that the protective layer contacts and covers the preform from the proximal edge to the distal edge.

An article attachable to an exterior surface of a vehicle includes a preform having a first surface and a second surface spaced opposite the first surface. The preform includes a substrate having an end surface, and a film disposed on the substrate and having a distal surface adjoining the end surface. The article further includes a protective layer formed from an injection-moldable polymer. The protective layer contacts and covers the second surface, the end surface, and the distal surface.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

### BRIEF DESCRIPTION OF THE DRAWINGS

FIG. 1 is a schematic illustration of an elevational view of an article attached to an exterior surface of a vehicle;

FIG. 2 is a schematic flowchart of a method of forming the article of FIG. 1;

FIG. 3 is a schematic cross-sectional illustration of a thermoplastic system for forming the article of FIG. 1;

FIG. 4 is a schematic cross-sectional illustration of a workpiece formed from the thermoplastic system of FIG. 3;

FIG. 5 is a schematic illustration of a side view of the thermoplastic system of FIG. 3 disposed between two heating stations;

FIG. 6 is a schematic partially cross-sectional illustration of the workpiece of FIG. 4 disposed between a mold surface and a pressure surface of a device configured for thermoforming;

FIG. 7 is a schematic fragmentary illustration of a top view of a portion of the mold surface of FIG. 6, wherein the mold surface defines a plurality of recessions therein;

FIG. 8 is a schematic partially cross-sectional illustration of a preform formed from the workpiece of FIG. 4 conformed to the mold surface of FIGS. 6 and 7;

FIG. 9 is a schematic cross-sectional illustration of the preform of FIG. 8 disposed within an apparatus configured for injection molding;

FIG. 10 is a schematic illustration of an elevational view of the article of FIG. 1 formed from the preform of FIG. 8 before attachment to the exterior of the vehicle of FIG. 1; and

FIG. 10A is a schematic cross-sectional illustration of the article of FIG. 10, taken along section lines 10A-10A.

### DETAILED DESCRIPTION

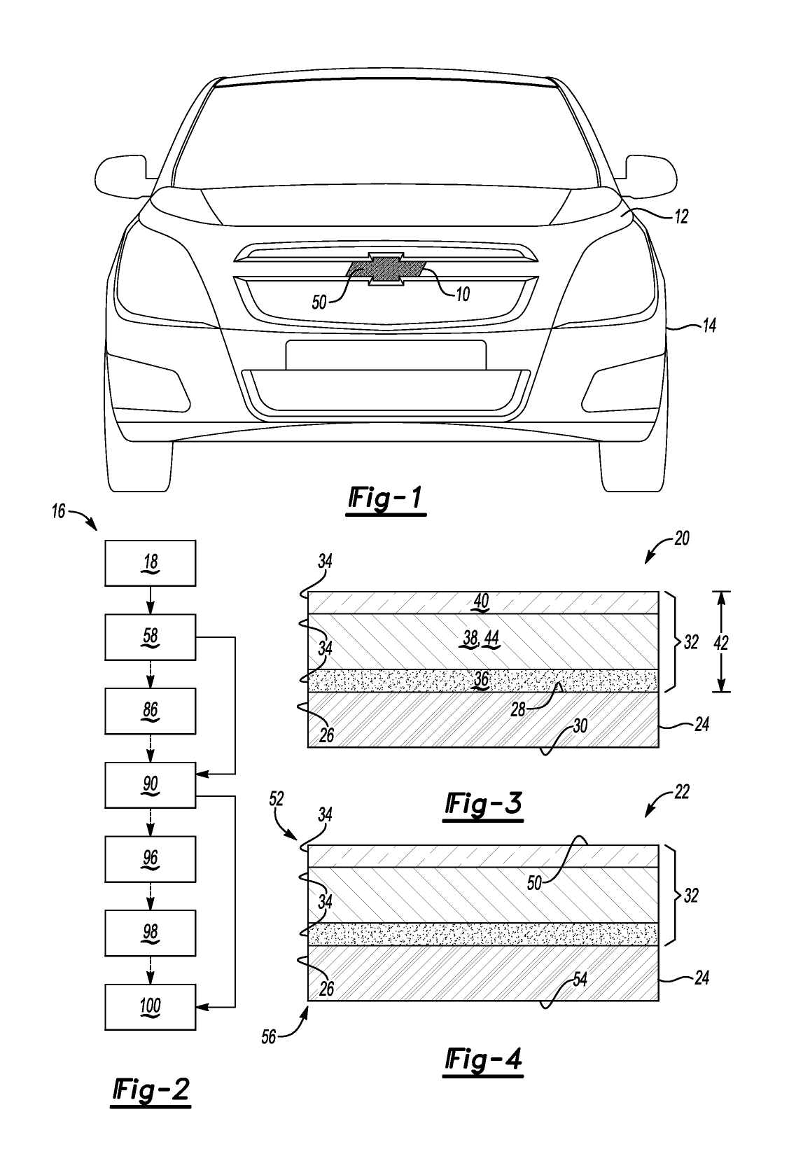

Referring to the Figures, wherein like reference numerals refer to like elements, an article 10 attachable to an exterior surface 12 of a vehicle 14 is shown generally in FIG. 1. For example, the article 10 may be an emblem or badge configured for attachment to the exterior surface 12 of an automotive vehicle. In another example, although not shown, the article 10 may be a body side molding or rocker useful for attachment to the exterior surface 12 of the automotive vehicle. However, the article 10 may also be useful for non-automotive applications, such as, but not limited to, construction, rail, aviation, and marine vehicles.

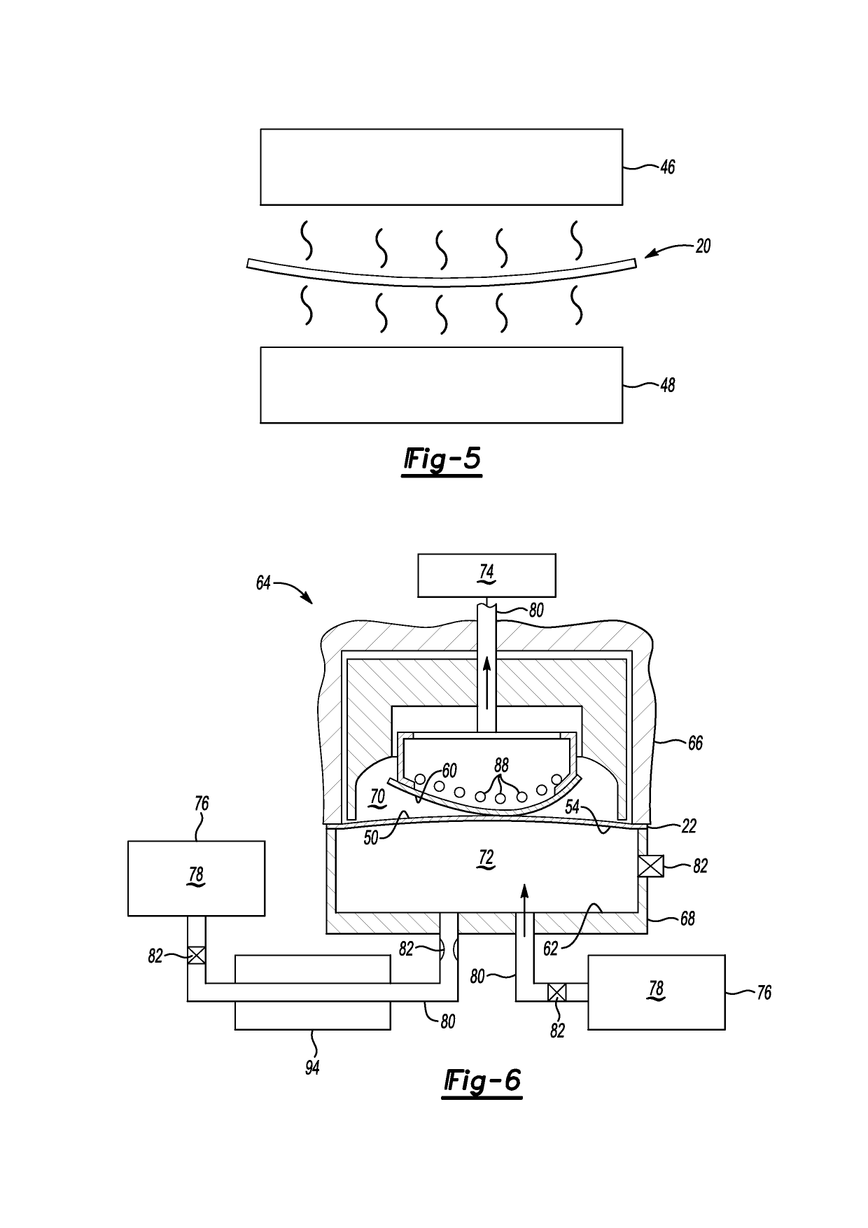

Referring now to FIG. 2, a method 16 of forming the article 10 (FIG. 1) is disclosed. The method 16 includes heating (represented generally by block 18 of FIG. 2 and illustrated generally in FIG. 5) a thermoplastic system 20 (FIG. 3) to form a workpiece 22 (FIG. 4). As used herein, the terminology workpiece 22 refers to a component or piece that undergoes subsequent processing, i.e., a work-in-process element.

As described with reference to FIG. 3, the thermoplastic system 20 includes a substrate 24 having an end surface 26. More specifically, as best shown in FIG. 3, the substrate 24 may have a coatable surface 28, an exposed surface 30 spaced opposite the coatable surface 28, and the end surface 26 adjoining the coatable surface 28 and the exposed surface 30. The substrate 24 may also be referred to as a carrier or backing, and may be formed from any suitable material. For example, the substrate 24 may be formed from a material selected from the group including acrylonitrile butadiene styrene, polycarbonate, thermoplastic polyolefin, thermoplastic polyurethane, polyester, vinyl copolymer, polyvinylchloride, polyethylene, and blends, copolymers, and/or alloys thereof.

With continued reference to FIG. 3, the thermoplastic system 20 also includes a film 32 disposed on the substrate 24 and having a distal surface 34 adjoining the end surface 26. As such, the thermoplastic system 20 may be characterized as a laminated thermoplastic sheet formed by a thermoforming process, as set forth in more detail below. The film 32 may be chemically and/or physically joined to the substrate 24. For example, the film 32 may be chemically bonded to the substrate 24. Alternatively, the film 32 may be adhered to the substrate 24 by, for example, an adhesive layer 36.

Referring again to FIG. 3, in one embodiment, the film 32 may include the adhesive layer 36 disposed on the substrate 24, e.g., on the coatable surface 28. The adhesive layer 36 may therefore adhere or join the film 32 to the substrate 24. Further, the adhesive layer 36 may physically and/or chemically join the film 32 to the substrate 24. Therefore, by way of non-limiting examples, the adhesive layer 36 may be an adhesive, a primer coating composition, a tie layer, a composition configured for compatibilizing the film 32 and the substrate 24, and/or an electrodeposition or e-coat coating composition.

With continued reference to FIG. 3, the film 32 may also include a first cured film 38 formed from a basecoat coating composition and disposed on the adhesive layer 36. For embodiments not including the adhesive layer 36, the first cured film 38 may be disposed on the coatable surface 28 of the substrate 24. The first cured film 38 may be formed from, for example, a colored paint composition, i.e., the basecoat coating composition, that may be tinted to a desired color, such as gold or red. In addition, for this embodiment, the film 32 may include a second cured film 40 formed from a clearcoat coating composition and disposed on the first cured film 38. That is, the second cured film 40 may provide the article 10 (FIG. 1) with gloss, sheen, and/or durability. As such, for this embodiment, the film 32 may be one or more paint or coating composition layers and may be characterized as a painted film. As best shown in FIG. 3, the film 32 may have a thickness 42 of from about 0.03 mm to about 0.12 mm, e.g., from about 0.06 mm to about 0.1 mm. In one embodiment, the film 32 may have a thickness 42 of from about 0.07 mm to about 0.09 mm.

With continued reference to FIG. 3, in another embodiment, the film 32 may include a formable metal layer 44 disposed on the adhesive layer 36. For embodiments not including the adhesive layer 36, the formable metal layer 44 may be disposed on the coatable surface 28 of the substrate 24. The formable metal layer 44 may be formed from a metal, such as aluminum or mixtures of aluminum and a nickel-based alloy including chromium and iron, e.g., a mixture of aluminum and Inconel®, that may be sputtered or otherwise formed on the adhesive layer 36. In addition, for this embodiment, the film 32 may also include the second cured film 40 formed from the clearcoat coating composition and disposed on the formable metal layer 44. As such, for this embodiment, the film 32 may be characterized as a bright film.

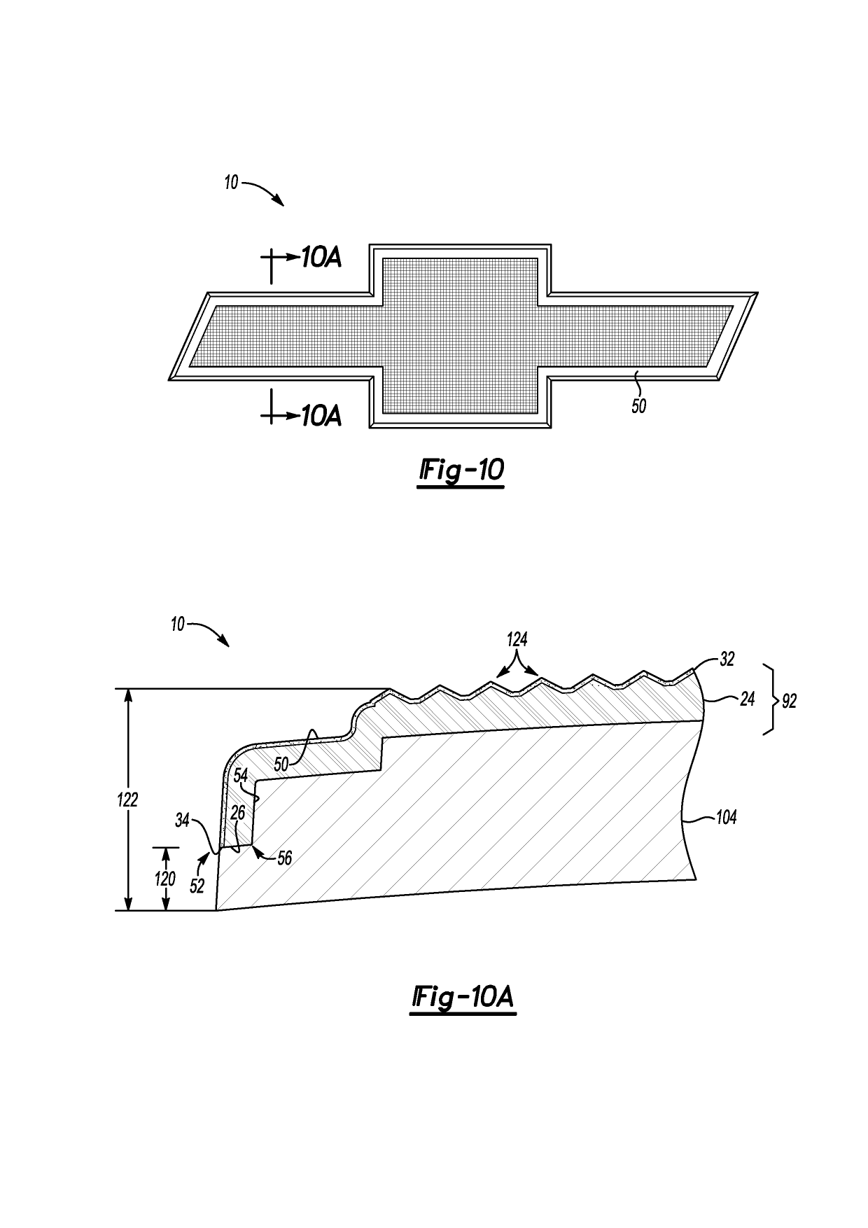

Referring now to FIG. 5, the thermoplastic system 20 may be heated in any suitable manner to form the workpiece 22 (FIG. 4). For example, the thermoplastic system 20 may be loaded onto a frame (not shown) and translated into one or more heating stations (shown generally at 46 and 48 in FIG. 5). The heating stations 46, 48 may each increase a temperature of the thermoplastic system 20 to, for example, from about 135° C. to about 205° C. By way of a non-limiting example, the one or more heating stations 46, 48 may be characterized as quartz, calrod, ceramic, and/or halogen. Upon heating 18 (FIG. 2), the thermoplastic system 20 may be in a moldably softened state in preparation for forming the workpiece 22 (FIG. 4) and eventual article 10 (FIGS. 1 and 10).

As described with reference to FIG. 4, the workpiece 22 has a first surface 50 adjoining the distal surface 34 to define a distal edge 52 therebetween. The first surface 50 may have a distinctness of image and a gloss. As used herein, the terminology distinctness of image refers to a characterization of the visual appearance of polished high-gloss surfaces. That is, distinctness of image indicates the sharpness of an image reflected by an object. More specifically, distinctness of image refers to a quantification of the deviation of light propagation from the regular direction by scattering during transmission or reflection. Distinctness of image may be measured in accordance with test method ASTM D5767-95 (2004). For the method 16 (FIG. 2), the first surface 50 may have a distinctness of image of greater than or equal to about 80 as measured in accordance with test method ASTM D5767-95 (2004).

Further, as used herein, the terminology gloss refers to a quantification of an ability of a surface, e.g., the first surface 50 (FIG. 4), to reflect light into the specular direction. That is, gloss is associated with the capacity of a surface to reflect more light in directions close to the specular direction than in other directions. As such, gloss is a measurement of the visual perception of objects, and is generally expressed in gloss units. For the method 16 (FIG. 2), the first surface 50 may have a gloss of greater than or equal to about 70 gloss units as measured in accordance with test method ASTM E40-11.

Accordingly, with continued reference to FIG. 4, the first surface 50 may have a class “A” surface finish. As used herein, the terminology class “A” refers to a surface finish that is suitable for a component forming or attached to the exterior surface 12 (FIG. 1) of the vehicle 14 (FIG. 1). That is, as compared to components suitable for forming or attachment to an interior surface (not shown) of the vehicle 14, a component having a class “A” surface finish has a surface having comparatively higher distinctness of image and gloss. Class “A” surfaces generally face an observer of the vehicle 14 who is positioned external to the vehicle 14.

Referring again to FIG. 4, the workpiece 22 has a second surface 54 spaced opposite the first surface 50. That is, the second surface 54 represents an opposite side of the workpiece 22 from the first surface 50. Generally, the second surface 54 is configured for facing and/or eventual attachment to the exterior surface 12 (FIG. 1) of the vehicle 14 (FIG. 1). Therefore, the first surface 50 may correspond to the film 32, e.g., the second cured film 40 (FIG. 3), and the second surface 54 may be configured for facing the exterior surface 12 of the vehicle 14 upon installation on the vehicle 14.

As best shown in FIGS. 4 and 10A, the second surface 54 also adjoins the end surface 26 to define a proximal edge 56 between the second surface 54 and the end surface 26. Therefore, the proximal edge 56 may be spaced apart from the distal edge 52.

Referring now to FIGS. 2, 6, and 8, the method 16 (FIG. 2) also includes disposing 58 (FIG. 2) the workpiece 22 (FIG. 6) between a mold surface 60 (FIGS. 6 and 8) and a pressure surface 62 (FIG. 6) spaced apart from the mold surface 60. In one non-limiting embodiment, the method 16 may include disposing 58 the workpiece 22 between the mold surface 60 and the pressure surface 62 so that the first surface 50 (FIGS. 6 and 8) faces the mold surface 60, and the second surface 54 (FIGS. 6 and 8) faces the pressure surface 62. That is, the first surface 50 may be turned toward or oriented opposite the mold surface 60, and the second surface 54 may be turned toward or oriented opposite the pressure surface 62. Alternatively, although not shown, the workpiece 22 may be disposed between the mold surface 60 and the pressure surface 62 so that the second surface 54 faces the mold surface 60 and the first surface 50 faces the pressure surface 62.

As described with reference to FIG. 6, the mold surface 60 and the pressure surface 62 may be respective components of a device 64 configured for thermoforming the thermoplastic system 20 (FIG. 3). As used herein, the terminology thermoforming refers to a process of heating a thermoplastic material, e.g., the thermoplastic system 20, and shaping the thermoplastic material in a cavity defined by a mold. By way of non-limiting example, the device 64 may include two components that are separable from and sealable to one another. For example, as shown in FIG. 6, the device 64 may include a vacuum box component 66 and a pressure box component 68, wherein the vacuum box component 66 includes the mold surface 60, and the pressure box component 68 includes the pressure surface 62. Therefore, for the method 16 (FIG. 2), the workpiece 22 may be oriented or disposed such that the first surface 50 thereof faces toward the vacuum box component 66, and the second surface 54 thereof faces toward the pressure box component 68.

With continued reference to FIG. 6, for the embodiment of the method 16 (FIG. 2) wherein the first surface 50 is spaced apart from the mold surface 60, the first surface 50 and the mold surface 60 may define a first cavity 70 therebetween. That is, the workpiece 22 may be disposed within the device 64 to seal off the vacuum box component 66 from the pressure box component 68 so as to define the first cavity 70 between the first surface 50 and the mold surface 60. Similarly, the second surface 54 and the pressure surface 62 may define a second cavity 72 therebetween. That is, the workpiece 22 may be disposed within the device 64 to seal off the vacuum box component 66 from the pressure box component 68 so as to define the second cavity 72 between the second surface 54 and the pressure surface 62. That is, the first cavity 70 and the second cavity 72 may not be disposed in fluid communication, but may rather be separately sealed from one another.

In addition, although shown disposed adjacent one another in FIG. 6, the vacuum box component 66 and the pressure box component 68 may be movable toward and away from one another. For example, the vacuum box component 66 may be stationary and initially spaced apart from the pressure box component 68 so that the workpiece 22 may be loaded into the device 64 and disposed therebetween. Subsequently, after disposing 58 (FIG. 2) the workpiece 22, e.g., between the mold surface 60 and the pressure surface 62 as set forth above, the pressure box component 68 may translate toward the vacuum box component 66 until a closed, air-tight seal is defined between the vacuum box component 66 and the pressure box component 68.

As shown in FIG. 6, the vacuum box component 66 and first cavity 70 may be fluidly connected to a vacuum source 74, e.g., a pump configured for drawing down a vacuum within the first cavity 70. As used herein, the terminology vacuum refers to any pressure below atmospheric pressure. Similarly, the pressure box component 68 and second cavity 72 may be fluidly connected to a pressure source 76, e.g., a pump configured for pressurizing the second cavity 72 with a compressed gas 78. As used herein, the terminology compressed gas 78 refers to gas having a pressure greater than atmospheric pressure. Suitable non-limiting examples of the compressed gas 78 include nitrogen and/or air. In addition, the device 64 may include one or more conduits 80 or valves 82 configured and arranged to convey fluid, e.g., the compressed gas 78 or air, to and from the vacuum source 74 and the pressure source 76.

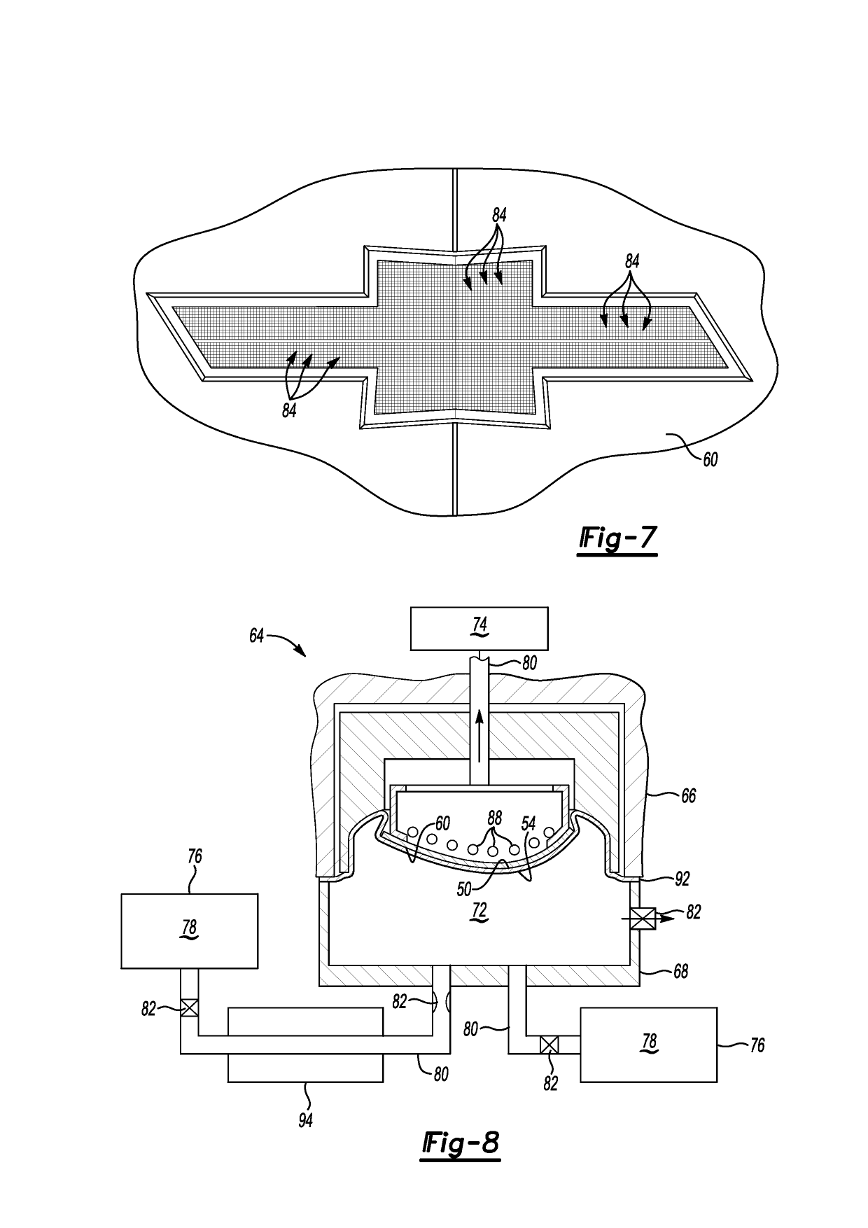

In addition, referring to FIGS. 6 and 8, the mold surface 60 may have a predetermined shape according to a desired shape of the article 10 (FIGS. 1 and 10). That is, as set forth in more detail below, the article 10 may be formed by shaping the first surface 50 to the mold surface 60 or pressure surface 62. In one embodiment, as shown in FIG. 7, the mold surface 60 may define a plurality of recessions 84 therein. For example, each of the plurality of recessions 84 may be spaced apart from one another to define a pattern on the mold surface 60 such as, but not limited to, striping, cross-hatching, a checkerboard, a bevel, a diamond-shape, and the like, which may form a desired texture on the article 10.

Referring again to the method 16 as described with reference to FIG. 2, after disposing 58, in one embodiment, the method 16 may include cooling 86 the mold surface 60 (FIG. 6) or pressure surface 62 (FIG. 6). For example, the method 16 may include, after disposing 58, cooling 86 the mold surface 60 to a temperature of less than or equal to about 38° C. That is, cooling 86 may reduce a temperature of the mold surface 60. The mold surface 60 or pressure surface 62 may be cooled in any manner. For example, as shown in FIG. 8, the device 64 may include a plurality of coolant lines 88 disposed adjacent the mold surface 60 through which a coolant or refrigerant, such as water, may flow to decrease the temperature of the mold surface 60. Such cooling 86 may contribute to the excellent distinctness of image and gloss of the formed article 10 (FIG. 1).

Referring now to FIGS. 2, 6, and 8, the method 16 (FIG. 2) also includes, after disposing 58 (FIG. 2), conforming 90 (FIG. 2) the first surface 50 (FIG. 6) to one of the pressure surface 62 (FIG. 6) and the mold surface 60 (FIG. 6) to thereby form a preform 92 (FIG. 8). That is, the first surface 50 may be molded to or pressed against the mold surface 60 or the pressure surface 62. For the embodiment including cooling 86 (FIG. 2) the mold surface 60, the method 16 includes conforming 90 after cooling 86. In one non-limiting example, conforming 90 may include concurrently evacuating the first cavity 70 (FIG. 6) and pressurizing the second cavity 72 (FIG. 6) to thereby dispose the first surface 50 in contact with the mold surface 60. That is, the first cavity 70 may be evacuated while the second cavity 72 is pressurized so that the first surface 50 is disposed adjacent and in contact with the mold surface 60.

More specifically, as described with reference to FIG. 6, evacuating may include exposing the first surface 50 to a vacuum of from about 33 KPa to about 75 KPa, e.g., from about 45 KPa to about 60 KPa, within the first cavity 70. Further, evacuating may expose the first surface 50 to the vacuum for a duration of from about 5 seconds to about 60 seconds. The vacuum source 74 may draw down a vacuum within the first cavity 70 so that the first surface 50 is pulled or sucked toward the mold surface 60 such that the first surface 50 contacts the mold surface 60 and conforms to the shape of the mold surface 60.

In addition, as also described with reference to FIG. 6, pressurizing may include applying a compressed gas (represented generally by 78 in FIG. 6) having a temperature of less than or equal to about 21° C. at a pressure of from about 345 KPa to about 1,035 KPa to the second surface 54. More specifically, pressurizing may include applying the compressed gas 78 having a temperature of from about 0° C. to about 16° C. at a pressure of from about 515 KPa to about 865 KPa to the second surface 54. Further, pressurizing may apply the compressed gas 78 to the second surface 54 for a duration of from about 5 seconds to about 40 seconds. To maintain the aforementioned temperature of the compressed gas 78 during pressurizing, the compressed gas 78 may pass through a chiller 94.

With continued reference to FIG. 6, the pressure source 76 may apply a pressure to the second surface 54 within the second cavity 72 so that the second surface 54 is pushed or pressed toward the mold surface 60 such that the first surface 50 contacts the mold surface 60 and conforms to the shape of the mold surface 60. That is, concurrently evacuating the first cavity 70 and pressurizing the second cavity 72 may mold the workpiece 22 so that the first surface 50 conforms to the shape of the mold surface 60 and thereby forms the preform 92 (FIG. 8). Stated differently, the pressure of the compressed gas 78 from the pressure source 76 may press against the second surface 54 of the workpiece 22 to thereby dispose the first surface 50 onto the mold surface 60, while the vacuum drawn by the vacuum source 74 draws the first surface 50 onto the mold surface 60.

Further, referring now to FIG. 6, after disposing 58 (FIG. 2), the method 16 (FIG. 2) may also include flushing 96 (FIG. 2) the second cavity 72 with the compressed gas 78 having a temperature of from about 0° C. to about 21° C. for a duration of from about 1 second to about 15 seconds, e.g., for from about 5 seconds to about 10 seconds. That is, the compressed gas 78 may pass through the chiller 94 and flush the second cavity 72 of the pressure box component 68 at a pressure of from about 515 KPa to about 865 KPa. Flushing 96 the second cavity 72 may advantageously chill the workpiece 22, e.g., the first surface 50, to a temperature of less than or equal to about 95° C. Ideally, the temperature of the first surface 50 is reduced to less than or equal to about 88° C. within 30 seconds, e.g., within 15 seconds, of conforming 90 (FIG. 2) the first surface 50 to the mold surface 60 or the pressure surface 62.

Referring again to FIG. 2, after conforming 90, the method 16 may include removing 98 the preform 92 (FIG. 8) from the device 64 (FIG. 8). That is, the method 16 may include separating the vacuum box component 66 (FIG. 8) and the pressure box component 68 (FIG. 8) so that the preform 92 (FIG. 8) may be released from the mold surface 60 (FIG. 8). In addition, depending upon the desired shape of the preform 92, the preform 92 may be further cooled and/or trimmed to size.

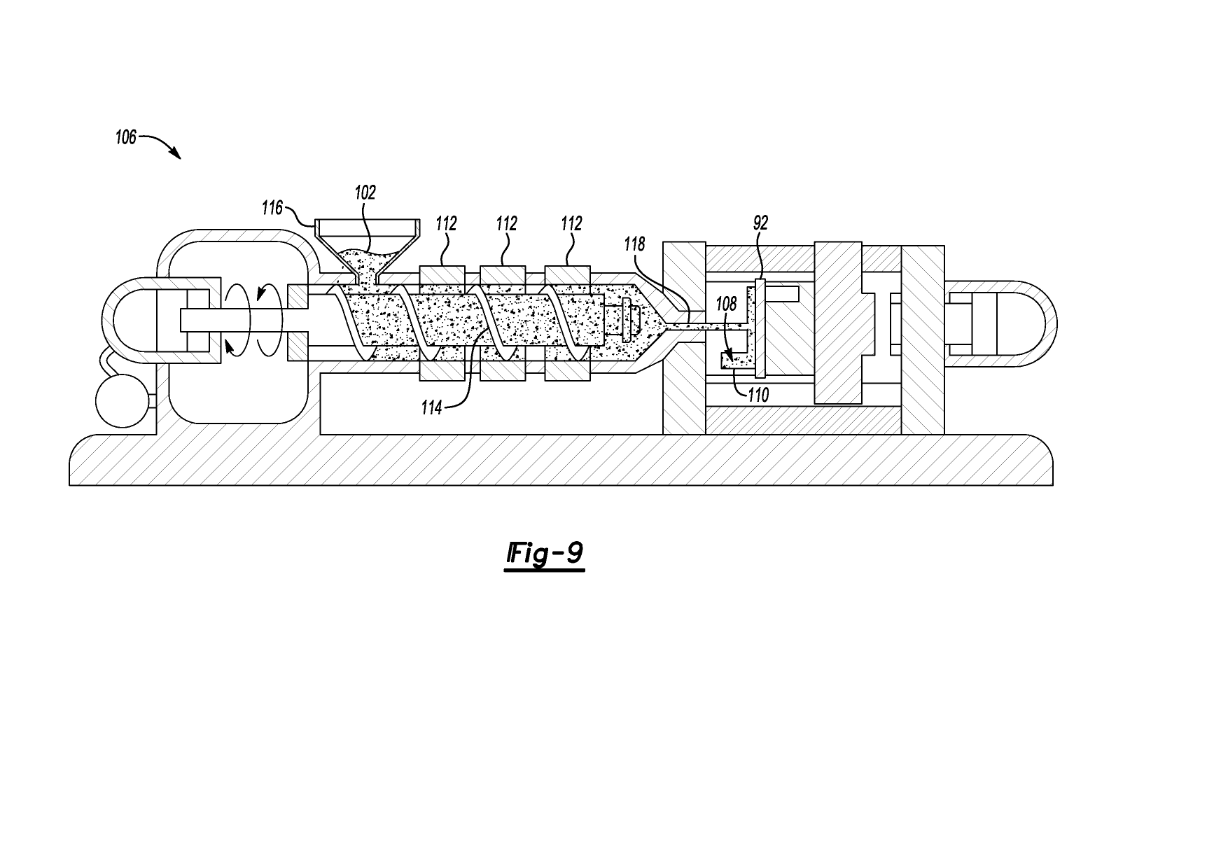

With continued reference to FIG. 2, the method 16 also includes depositing 100 an injection-moldable polymer 102 (FIG. 9) onto the preform 92 (FIG. 9) to form a protective layer 104 (FIG. 10A) thereon and thereby form the article 10 (FIGS. 1 and 10). In particular, the protective layer 104 contacts and covers the distal surface 34, as set forth in more detail below.

As used herein, the terminology injection molding refers to a process of shaping or molding the injection-moldable polymer 102 (FIG. 9) or resin by, for example, heating, mixing, and/or feeding the injection-moldable polymer 102 into a cavity defined by a mold, and subsequently cooling the injection-moldable polymer 102 to thereby harden the injection-moldable polymer 102 according to a shape of the cavity. Suitable injection-moldable polymers 102 may be selected from the group including thermoplastic polymers such as, but not limited to, nylon, polystyrene, polypropylene, polyethylene, acrylonitrile butadiene styrene, and thermoplastic polyolefins; thermosetting polymers such as, but not limited to, epoxies and phenolic resins; elastomers such as, but not limited to, polybutadiene, ethylene propylene rubber, and ethylene propylene diene rubber; and combinations thereof.

More specifically, with continued reference to FIGS. 9 and 10A, depositing 100 (FIG. 2) may include injection molding the injection-moldable polymer 102 (FIG. 9) onto the preform 92 (FIG. 9) so that the protective layer 104 (FIG. 10A) contacts and covers the preform 94 from the proximal edge 56 (FIG. 10A) to the distal edge 52 (FIG. 10A). Therefore, the protective layer 104 contacts and covers the distal surface 34 (FIG. 10A). As such, the protective layer 104 may form a barrier between contaminants, e.g., dirt, chemicals, fluids, and the like, and the distal surface 34. That is, the protective layer 104 may prevent contaminants from contacting the distal surface 34 of the film 32 (FIG. 10A). As such, the protective layer 104 may protect the distal surface 34 of the film 32 from potential degradation and/or corrosion.

As shown generally in FIG. 9, depositing 100 (FIG. 2) may include, in sequence, arranging the preform 92 within an apparatus 106, e.g., an injection molding machine, to define a void 108 therebetween. That is, the method 16 (FIG. 2) may include placing the preform 92 within a cavity, i.e., the void 108, of a mold 110 having a desired shape or configuration. Depositing 100 may further include injecting or feeding the injection-moldable polymer 102, which may be heated by one or more heaters 112, into the void 108 so that the injection-moldable polymer 102 contacts the second surface 54 (FIG. 10A). For example, the injection-moldable polymer 102 may be fed via a reciprocating screw 114 from a hopper 116 through a nozzle 118 into the void 108, and may contact the second surface 54 of the preform 92 disposed within the void 108. Further, depositing 100 may include, after injecting, cooling the injection-moldable polymer 102 so that the protective layer 104 (FIG. 10A) contacts and covers the end surface 26 (FIG. 10A) and the distal surface 34 (FIG. 10A).

More specifically, as described with reference to FIGS. 9 and 10A, cooling the injection-moldable polymer 102 (FIG. 9) may include shaping the injection-moldable polymer 102 so that the protective layer 104 (FIG. 10A) contacts and covers only the second surface 54 (FIG. 10A), the end surface 26 (FIG. 10A), and the distal surface 34 (FIG. 10A), and does not cover the first surface 50 (FIG. 10A). That is, as best shown in FIG. 10A, the protective layer 104 may contact and cover the second surface 54, wrap around the proximal edge 56, contact and cover the end surface 26 and the distal surface 34, and abut the distal edge 52. Stated differently, the method 16 (FIG. 2) may further include contacting and covering the second surface 54 with the protective layer 104, wherein the protective layer 104 abuts the distal edge 52. In addition, although not shown, the protective layer 104 may provide attachment devices such as pegs or notches (not shown) configured for attaching the article 10 to the exterior surface 12 (FIG. 1) of the vehicle 14 (FIG. 1), and therefore, may reduce the assembly complexity of the vehicle 14. The protective layer 104 may extend from the distal surface 34 and the end surface 26, and may have a height 120 of from about 1 mm to about 3 mm at the distal edge 52.

Therefore, referring again to FIG. 10A, the article 10 includes the preform 92 having the first surface 50 and the second surface 54 spaced opposite the first surface 50. The preform 92 includes the substrate 24 having the end surface 26, and the film 32 disposed on the substrate 24 and having the distal surface 34 adjoining the end surface 26. The article 10 also includes the protective layer 104 formed from the injection-moldable polymer 102 (FIG. 9), wherein the protective layer 104 contacts and covers the second surface 54, the end surface 26, and the distal surface 34. That is, the protective layer 104 may not cover the first surface 50.

As best shown in FIG. 10A, the article 10 may have a thickness 122 of from about 5 mm to about 15 mm, e.g., from about 7 mm to about 13 mm. If desired, the article 10 may also include a mask layer (not shown) removably disposed on the article 10 and configured for protecting the article 10 before the article 10 is attached to the exterior surface 12 (FIG. 1) of the vehicle 14 (FIG. 1). As such, the method 16 (FIG. 2) is useful for applications requiring articles 10 having intricate designs, such as lettering, numerals, and comparatively sharp corners or junctions.

Referring again to FIG. 10A, for the embodiment of the mold surface 60 (FIG. 7) defining the plurality of recessions 84 (FIG. 7) therein, the resulting article 10 formed by the method 16 (FIG. 2) includes a plurality of protrusions 124 thereon each corresponding to a respective one of the plurality of recessions 84. That is, the formed article 10 may have a textured appearance. It is to be appreciated that such textured appearance is achievable since the method 16 includes conforming 90 (FIG. 2) the first surface 50, rather than the second surface 54, to the mold surface 60 or pressure surface 62.

The article 10 (FIGS. 1 and 10) formed by the method 16 (FIG. 2) has the distinctness of image and the gloss set forth above. That is, the initial distinctness of image and initial gloss of the first surface 50 (FIG. 4) of the workpiece 22 (FIG. 4) does not substantially change during the method 16 so that the formed article 10 also has the initial distinctness of image and the initial gloss. In particular, conforming 90 (FIG. 2) the first surface 50 to one of the mold surface 60 (FIG. 6) and the pressure surface 62 (FIG. 6), e.g., the mold surface 60, may preserve the distinctness of image and the gloss of the workpiece 22 and preform 92 (FIG. 9) during formation of the article 10. Stated differently, the article 10 maintains the distinctness of image and the gloss of the workpiece 22 and preform 92. As such, the article 10 has the class “A” surface finish, and is suitable for attachment to the exterior surface 12 (FIG. 1) of the vehicle 14 (FIG. 1). Without intending to be limited by theory, conforming 92 the first surface 52, rather than the second surface 54, to the mold surface 62 or pressure surface 64 may contribute to such excellent distinctness of image and gloss. Further, cooling 88 (FIG. 2) the mold surface 62 may also contribute to the excellent distinctness of image and gloss.

Further, the aforementioned method 16 (FIG. 2) forms articles 10 (FIGS. 1 and 10) having minimized corrosion and/or degradation from, for example, filiform corrosion, galvanic corrosion, and/or bimetallic charge dissipation. In particular, the protective layer 104 (FIG. 10A) that contacts and covers the distal surface 34 (FIG. 10A) minimizes contact between the film 32 (FIG. 10A) and/or substrate 24 (FIG. 10A) and contaminants such as dirt, chemicals, and fluids that may contribute to corrosion and/or degradation of the article 10. That is, the protective layer 104 may insulate and protect the film 32 from contaminants. Therefore, the method 16 forms articles 10 having a class “A” surface, excellent durability, and optional excellent definition of texture. Further, the method 16 economically produces articles 10 within desired production cycle times, and provides articles 10 having excellent durability that are suitable for attachment to the exterior surface 12 of the vehicle 14. As such, the method 16 allows for economical and efficient formation of the article 10, and the article 10 contributes to an increased perceived quality of the vehicle 14.

While the best modes for carrying out the disclosure have been described in detail, those familiar with the art to which this disclosure relates will recognize various alternative designs and embodiments for practicing the disclosure within the scope of the appended claims.

1. A method of forming an article attachable to an exterior surface of a vehicle, the method comprising:
heating a thermoplastic system to form a workpiece, wherein the thermoplastic system includes:
a substrate having an end surface; and
a film disposed on the substrate and having a distal surface adjoining the end surface;
wherein the workpiece has:
a first surface adjoining the distal surface to define a distal edge therebetween; and
a second surface spaced opposite the first surface and adjoining the end surface to define a proximal edge between the second surface and the end surface;
disposing the workpiece between a mold surface and a pressure surface spaced apart from the mold surface;
after disposing, conforming the first surface to one of the pressure surface and the mold surface to thereby form a preform; and
depositing an injection-moldable polymer onto the preform to form a protective layer thereon and thereby form the article, wherein the protective layer contacts and covers the distal surface.

2. The method of claim 1, further including contacting and covering the second surface with the protective layer, wherein the protective layer abuts the distal edge.

3. The method of claim 1, wherein depositing includes injection molding the injection-moldable polymer onto the preform so that the protective layer contacts and covers the preform from the proximal edge to the distal edge.

4. The method of claim 3, wherein depositing includes, in sequence:
arranging the preform within an apparatus to define a void therebetween;
injecting the injection-moldable polymer into the void so that the injection-moldable polymer contacts the second surface; and
after injecting, cooling the injection-moldable polymer so that the protective layer contacts and covers the end surface and the distal surface.

5. The method of claim 4, wherein cooling the injection-moldable polymer includes shaping the injection-moldable polymer so that the protective layer contacts and covers only the second surface, the end surface, and the distal surface, and does not cover the first surface.

6. The method of claim 4, wherein the protective layer extends from the distal surface and the end surface, and has a height of from about 1 mm to about 3 mm at the distal edge.

7. The method of claim 1, wherein the first surface and the mold surface define a first cavity therebetween, and wherein the second surface and the pressure surface define a second cavity therebetween, and further wherein conforming includes concurrently evacuating the first cavity and pressurizing the second cavity to thereby dispose the first surface in contact with the mold surface.

8. The method of claim 7, wherein pressurizing includes applying a compressed gas having a temperature of less than or equal to about 21° C. at a pressure of from about 345 KPa to about 1,035 KPa to the second surface.

9. The method of claim 8, wherein pressurizing applies the compressed gas to the second surface for a duration of from about 5 seconds to about 40 seconds.

10. The method of claim 7, wherein evacuating includes exposing the first surface to a vacuum of from about 33 KPa to about 75 KPa within the first cavity.

11. The method of claim 10, wherein evacuating exposes the first surface to the vacuum for a duration of from about 5 seconds to about 60 seconds.

12. The method of claim 1, further including, after disposing, cooling the mold surface to a temperature of less than or equal to about 38° C.

13. The method of claim 1, further including, after disposing, flushing the second cavity with a compressed gas having a temperature of from about 0° C. to about 21° C. for a duration of from about 1 second to about 15 seconds.

14. A method of forming an article attachable to an exterior surface of a vehicle, the method comprising:
heating a thermoplastic system to form a workpiece, wherein the thermoplastic system includes:
a substrate having an end surface; and
a film disposed on the substrate and having a distal surface adjoining the end surface;
wherein the workpiece has:
a first surface adjoining the distal surface to define a distal edge therebetween; and
a second surface spaced opposite the first surface and adjoining the end surface to define a proximal edge between the second surface and the end surface;
disposing the workpiece between a mold surface and a pressure surface spaced apart from the mold surface so that the first surface faces the mold surface and the second surface faces the pressure surface;
wherein the first surface and the mold surface define a first cavity therebetween, and
wherein the second surface and the pressure surface define a second cavity therebetween;
after disposing, conforming the first surface to the mold surface to thereby form a preform, wherein conforming includes concurrently evacuating the first cavity and pressurizing the second cavity to thereby dispose the first surface in contact with the mold surface; and
depositing an injection-moldable polymer onto the preform to form a protective layer thereon and thereby form the article, wherein the protective layer contacts and covers the second surface and the distal surface;
wherein depositing includes injection molding the injection-moldable polymer onto the preform so that the protective layer contacts and covers the preform from the proximal edge to the distal edge.

15. An article attachable to an exterior surface of a vehicle, the article comprising:
a preform having a first surface and a second surface spaced opposite the first surface, the preform including:
a substrate having an end surface; and
a film disposed on the substrate and having a distal surface adjoining the end surface; and
a protective layer formed from an injection-moldable polymer, wherein the protective layer contacts and covers the second surface, the end surface, and the distal surface.

16. The article of claim 15, wherein the protective layer does not cover the first surface.

17. The article of claim 16, wherein the film includes:
an adhesive layer disposed on the substrate;
a first cured film formed from a basecoat coating composition and disposed on the adhesive layer; and
a second cured film formed from a clearcoat coating composition and disposed on the first cured film;
wherein the film has a thickness of from about 0.04 mm to about 0.12 mm.

18. The article of claim 16, wherein the film includes:
an adhesive layer disposed on the substrate;
a formable metal layer disposed on the adhesive layer; and
a second cured film formed from a clearcoat coating composition and disposed on the formable metal layer;
wherein the film has a thickness of from about 0.04 mm to about 0.12 mm.
